(19) United States
(12) Patent Application Publication
(10) Pub. No.: US 2003/0020795 A1
(43) Pub. Date: Jan. 30, 2003

(54) Method and device for drying ink-jet prints

(76) Inventors: Kai K O Bär, Bruchm?uuml;hl (DE); Rainer Gaus, Bruchm?uuml;hl (DE); Rolf Wirth, Bruchm?uuml;hl-Heufeld (DE)

Correspondence Address: Roger A Heppermann, Marshall Gerstein & Borun, 6300 Sears Tower, 233 South Wacker Drive, Chicago, IL, 60606-6357, US

(21) Appl. No.: 10/089,953

(22) PCT Filed: Aug. 7, 2001
(86) PCT No.: PCT/EP01/09146

(30) Foreign Application Priority Data
Aug. 9, 2000 (DE) 100-38-897.3

(51) Int. Cl. B41J 2/01

(52) U.S. Cl. 347/102

(57) ABSTRACT

Method of drying an ink-jet print on a print-image carrier by means of infrared radiation, wherein the image carrier is transported through a strip-shaped irradiation zone and a radiation source is operated in such a way that radiation in the near-infrared region, in particular with a wavelength between 0.8 and 1.5 μm, acts on the ink-jet print substantially over the entire surface of the print image.

### DESCRIPTION

The present invention relates to a method and an apparatus for drying ink-jet prints by the application of electromagnetic radiation in the infrared region.

Ink-jet printing equipment that operates with non-penetrating ink, i.e. ink that does not soak into the medium on which it is imprinted, produces a distinctly better print image on the paper used in offices than do printers that operate with penetrating ink. A disadvantage of using non-penetrating ink is that it dries more slowly, so that there is a risk that the image may become blurred when the printed paper is removed from the machinery and stored.

Hence a common practice is that after a printing process, prints made with inks that have been applied in the liquid state, in particular non-penetrating inks, are dried by the application of heat to warm them above the ambient temperature, in order to keep the time between printing and ultimate fixation as small as possible.

The conventional approach to such drying is to employ heated rollers in a procedure subsequent to the printing, namely to pass the medium bearing the print image (the image carrier) over these rollers. A procedure is also known in which an irradiation device that covers a large area generates thermal radiation that is applied to the image carrier.

It is disadvantageous that when such means of fixing the image on an image carrier are used, the drying speed is limited, and hence so is the speed of the whole printing process. These restrictions derive, firstly, from the dimensioning and layout of the heat source and the degree to which it can apply large amounts of heat to the image carrier within a short time. When the unspecifically introduced thermal energy is absorbed at a relatively high rate, the rise in temperature over a given period of time is so great that embrittlement and undesirable strong drying effects negatively affect the quality of the end product, as well as its ability to tolerate further processing.

In the patent DE 36 42 204 a drying process is described in which the printed paper is pulled over a heating saddle. This heats the back surface of the paper and thereby dries the ink. During this process the printed pages are placed under tension within an additional propulsion device, which holds them over a heating apparatus consisting of a heated piece of sheet metal. To accelerate the drying process, where appropriate a hot-air blower can also be employed, which supplements the effect by transferring the heated air above the heating device to the image carrier.

An ink-printer apparatus that operates in a similar way is described in the patent DE 27 16 705.

A disadvantage of this kind of drying is that the image carrier is completely heated, which necessitates a high heat output, and that because it is heated on only one side, it can become deformed. Furthermore, the energy consumption is unnecessarily high.

In the patent DE 40 21 227 the paper printed by means of an ink print head is fed through a laminar slot within which, by means of a warm-air blower with associated air-distributor device, a laminar stream of warm air with low flow velocity is produced. This warm airflow dries the applied ink reliably and with no blurring while the paper is still within the slot, and at the same time the moisture is conducted away.

This solution presents the disadvantage that it is technically elaborate and the apparatus consequently has a greater weight. Other disadvantages are that the blower produces noise and that the dryer can be relatively susceptible to failure.

The patent DE 198 35 046 describes a drying process that depends on the print image; it employs an image-monitoring device that is designed to detect where the image created by the ink is positioned on the image carrier and to emit appropriate electronic position-control signals. A heat source that can be operated in pulses is provided to produce a punctate beam with an infrared component that is aimed at the image carrier. Associated with the heat source is a controlling and positioning apparatus, which in response to the position-control signal guides the infrared beam to the printed image so that the drying of the ink is carried out in an image-dependent manner. This solution requires very elaborate controllers and, again, is relatively susceptible to failure.

The patent DE 198 07 643 describes a method of drying a layer of printing ink on the surface of a carrier material that is being rapidly transported in a transport direction. In a drying zone incident electromagnetic radiation separates a moisture component, in particular a solvent, from the material to be dried and the separated moisture component is transported away from the drying zone by a transport gas current. Electromagnetic radiation, in particular in the near-infrared region, has proved especially useful for drying. This method consumes a relatively large amount of energy.

The objective of the present invention is to make available a method and an apparatus that enable short drying times and hence high printing speeds combined with high energy efficiency in the case of an ink-jet printer that is in continuous operation, with no deterioration in the quality of the image carrier or impediments to its further processing.

This objective is achieved by a method with the characteristics given in claim 1 and an apparatus with the characteristics given in claim 8. Advantageous embodiments of the invention are described in the subordinate claims.

The invention includes the fundamental idea that, in view of the absorption and reflection properties of the inks customarily used for ink-jet printing on one hand, and those of the papers that are by far the most commonly used as image carriers on the other hand, electromagnetic radiation in the near-infrared region, specifically in the wavelength region between 0.8 and 1.5 μm, should be used to dry ink-jet prints. It also includes the idea that for this purpose a substantially strip-like (in the form of an elongated rectangle) irradiation zone should be created, through which the image carrier is conveyed. Finally, the invention also includes the idea of exposing substantially the entire surface of the print image to this radiation, but not macroregions of the carrier that lie outside the outer contour of the print image.

The last statement should be understood in the context of the invention as follows: large, uninterrupted regions of the print image (e.g. a letterhead, an address field and text sections of a business letter or the regions of a constructional drawing that show particular parts) are exposed over the entire area within their particular outer contour, or at least line by line, to the NIR radiation. Focussing of the radiation onto the ink-jet trace (which in the sense of the above use of the term “macroregions” could also be termed the “microregion” of the print image) is required, nor is there a large-area irradiation of the image carrier without regard for the actual presence of a print image. The type of irradiation in accordance with the invention is advantageously accomplished by controlling the shape of the irradiation zone and/or the operation of the radiation source itself, in dependence on the outer contour of the print image.

In a currently preferred embodiment the radiation in the near-infrared region (in the following abbreviated to NIR radiation) is generated by an elongated halogen lamp operated at an elevated temperature, with a reflector elongated to match the shape of the halogen lamp—in particular with a cross section corresponding substantially to (part of) an ellipse.

In another embodiment, significant in perspective, a number of substantially punctate NIR radiators, in particular NIR light-emitting diodes, are likewise employed in combination with an elongated reflector with preferably part-elliptical cross sections.

The specific configuration of the reflector in both embodiments is selected in accordance with the shape of the NIR radiation source actually in use and with the preferred area in which the ink-jet printer is to be employed. A design suitable for many practical applications provides a strip-shaped irradiation zone, the maximal length of which matches the maximal width of the print-image carrier to be dried, and the height of which matches the height of the lines of print customarily used in private or business correspondence. For particular applications—e.g., for ink-jet printers specially designed for printing out drawings or for printing textiles—it may be more advantageous to use reflectors with a parabolic shape, which can generate a wider irradiation zone. For universally employable ink-jet printers in the high-performance category, where appropriate an adjustable reflector geometry (implemented, e.g., by adjustable reflector lamellae) can be employed.

The above-mentioned adjustment of the shape of the irradiation zone in dependence on the outer contour of the print image is achieved by means, preferably, of an irradiation-control device driven by a sensor that detects the outer contour of the print image. The irradiation-control device comprises in particular a controllable aperture and/or shutter device by means of which the NIR radiation is transmitted only to the regions of the print-image carrier that actually bear a print image, whereas the remaining regions of the carrier are shielded from the radiation.

An aperture or shutter device of this kind can have a mechanical construction known per se, with a displaceable radiation barrier (“curtain”) that in particular obscures particular sections of the total longitudinal extent of the radiation zone. However, an arrangement preferable to this mechanical construction, because it is more rapidly controllable and less subject to interference, is an electro-optical aperture or shutter device. The latter is implemented, for example, by an LCD arrangement with a length corresponding to the maximal longitudinal extent of the irradiation zone, which is subdivided into a plurality of individually actuatable regions.

So that the length of the irradiation zones can be varied in accordance with the actual print image, such an LCD arrangement comprises in particular an adequate number of control regions arranged in a row to form a “shutter line”. These cause specific sections of the length (height) of the image carrier to be blocked off by completely closing (darkening of all controlled regions) the aperture or shutter device for predetermined time periods as the image carrier is being transported. A mechanical aperture or shutter device can also operate in the same way, by preventing the NIR radiation from reaching particular regions of the image carrier that are defined by their length or height.

In combination with an aperture or shutter device of the kind described above, or where appropriate independently of such devices, the invention is advantageously designed with a controllable NIR radiation source. The controllability comprises in particular the ability to turn the source on and off with brief response times, so as to implement a pulsed operation and/or a rapid alteration of the radiation output.

In the above-mentioned embodiment of the radiation source as lines of substantially punctate NIR radiators, the latter are preferably individually actuatable, so that as the image carrier is transported through the irradiation zone, the length of the zone can be altered depending on the particular image, by actuating a more or less large number of the individual NIR radiators.

In another preferred embodiment, before and/or during the irradiation (i.e., in particular in a measurement region disposed ahead of or within the actual irradiation zone) a physical parameter of the ink-jet print or the image carrier or—preferably—both of these is measured and the result of the measurement is used to control the irradiation. Especially preferred in this regard is a measurement of the brightness or the degree of absorption in the printed regions in comparison to the unprinted carrier, or a temperature measurement or, for certain applications, a measurement of the moisture content in the ink-covered regions. In particular, detection of the colour of the applied ink is useful to control the amount of irradiation required for the particular case, and/or to adjust the wavelength region of the applied NIR radiation where appropriate.

The above-mentioned setting of an image-specific wavelength region for the NIR radiation used for drying (which can be desirable in particular for high-quality printers or printers designed for special applications) can in particular be brought about by swivelling optical band- or edge-filters that are known per se into the beam path between radiation source and surface of the image carrier. Alternatively, electro-optically controllable filters can in principle be employed.

An apparatus that provides the various means of control described above of course comprises at least one sensor to detect the relevant physical quantity or quantities, i.e. in particular one or more photoelectric sensors to monitor the brightness and/or colour of the image or image carrier, a non-contact (in particular pyrometric) temperature sensor, and in some cases a moisture sensor.

To implement an automatic adjustment of the irradiation parameters, such a sensor or sensors is/are connected by way of their evaluation circuitry in particular to a control input or control inputs of the irradiation control device. A suitable control algorithm ensures the adequate setting of the irradiation parameters in dependence on the measurements produced by the sensor(s). Because a closed control loop is provided, a well-regulated operation is made possible, which in particular can be helpful for carrying out drying procedures in the case of printing processes with markedly fluctuating print parameters—for instance, widely varying print-image density, nonuniformly printed image carriers and so on.

A considerable enhancement of the drying effect is achieved when the action of the NIR radiation is reinforced by the action of an air current that passes over the surface of the image carrier. The latter accelerates the removal of the solvent vapours that the NIR radiation has released from the ink layer. Furthermore, it cools the surface of the image carrier and thereby (in the sense of producing a “cold” image carrier) reinforces the specific action of the NIR radiation.

In the simplest case such an airstream can be implemented as a convection airstream by positioning air-conducting devices, in particular plastic conduction plates or films, next to the apparatus that transports the image carrier. A more elaborate means, which however allows considerable greater effects to be achieved, is to provide a blower device that generates an air current that passes over the maximal width of the image carrier.

The implementation of the invention is not limited to the aspects and preferred variants of embodiments described here, but in the context of the attached claims is also possible in a plurality of modifications that are within the scope of those skilled in the art.

1. Method of drying an ink-jet print on a print-image carrier by means of infrared radiation,
characterized in that the image carrier is transported through a strip-shaped irradiation zone and a radiation source is operated in such a way that radiation in the near-infrared region, in particular with a wavelength between 0.8 and 1.5 μm, acts on the ink-jet print substantially over the entire surface of the print image.

2. Method according to claim 1,
characterized in that the radiation in the near-infrared region is produced by an elongated halogen lamp operated at a high temperature, in particular with a radiation temperature above 2500 K, and equipped with an elongated reflector.

3. Method according to claim 1,
characterized in that the radiation in the near-infrared region is produced by a row of approximately punctate NIR radiators that share a single elongated reflector.

4. Method according to one of the preceding claims,
characterized in that the shape of the irradiation zone and/or the operation of the radiation source is/are controlled in dependence on an outer contour of the print image, in such a way that macroregions of the image carrier beyond the outer contour of the print image are exposed to substantially no radiation.

5. Method according to claim 4,
characterized in that an ink-jet print in text format is dried line by line, with an irradiation zone that conforms substantially to the shape of a line of text.

6. Method according to one of the preceding claims,
characterized in that the ink-jet print, while within the irradiation zone or after passing through it, is exposed to an airstream generated by convection or by a ventilator in order to dissipate solvent vapours, the airstream being directed substantially parallel to the surface of the image carrer.

7. Method according to one of the preceding claims,
characterized in that ahead of and/or in the irradiation zone at least one physical parameter of the ink-jet print and/or of the image carrier, in particular the colour of the ink, the brightness or degree of absorption and/or the temperature and/or the moisture content, is/are measured and the result of the measurement is evaluated and used to control the irradiation.

8. Apparatus for implementing the method according to one of the preceding claims,
characterized by a radiation source disposed above the surface of the image carrier on which the ink-jet print is formed and aimed in the direction thereof, which emits electromagnetic radiation the effective component of which is substantially in the near-infrared region, in particular in the wavelength region between 0.8 μm and 1.5 μm, and which produces a strip-shaped irradiation zone.

9. Apparatus according to claim 8,
characterized in that the radiation source comprises an elongated halogen lamp operated at a high temperature and an elongated reflector, which in particular has substantially the cross-sectional shape of a section of an ellipse.

10. Apparatus according to claim 9,
characterized in that the radiation source comprises a row of substantially punctate NIR radiators, in particular NIR-LEDs, as well as an elongated reflector, which in particular has substantially the cross-sectional shape of a section of an ellipse.

11. Apparatus according to one of the claims 8 to 10,
characterized by an irradiation-control device, which in particular comprises a controllable aperture and/or shutter arrangement, and
a print-image detection device, connected to an input of the irradiation-control device and serving to detect the outer contour of the print image
to control the shape of the irradiation zone and/or the operation of the radiation source in dependence on the outer contour of the print image.

12. Apparatus according to claim 11,
characterized by at least one measurement device to detect a physical parameter of the ink-jet print and/or the image carrier, in particular the colour of the ink, the brightness or absorptance and/or the temperature and/or the moisture content, which in particular is connected to a control input of the irradiation-control device.

13. Apparatus according to claim 11 or 12,
characterized by a control device to carry out the irradiation in a closed control circuit.

14. Apparatus according to one of the claims 8 to 13,
characterized by an apparatus to generate an airstream that is in particular substantially parallel to the surface of the image carrier and hence is directed towards the ink-jet print for the purpose of drying the latter, in particular an apparatus that conducts the airstream over the width of the image carrier by convection or a blower that passes the air over the width of the image carrier.

15. Ink-jet printer with an apparatus according to one of the claims 9 to 14.
